(19) United States
(12) Patent Application Publication
(10) Pub. No.: US 2020/0239643 A1
(43) Pub. Date: Jul. 30, 2020

(54) BISON FIBER INSULATION AND METHOD OF PRODUCING BISON FIBER INSULATION

(71) Applicant: Sand Shack LLC, Philadelphia, PA (US)

(72) Inventor: Brian Thomas Linton, Philadelphia, PA (US)

(21) Appl. No.: 16/749,574

(22) Filed: Jan. 22, 2020

Related U.S. Application Data
(60) Provisional application No. 62/796,210, filed on Jan. 24, 2019.

(51) Int. Cl. C08H 1/06; B32B 27/36; C08L 89/04

(52) U.S. Cl. CPC C08H 1/06; A41D 31/06; C08L 89/04; B32B 27/36

(57) ABSTRACT

The disclosed embodiments include a blend of bison fibers, another fiber, and adhesives. The bison fibers are sheared from a bison, scoured, dehaired, blended with various other fibers and/or compositions, carded, and manufactured into insulation. The bison hairs can be categorized by diameter into one of four categories: prime, drop A, drop B, or drop C. Furthermore, bison fiber can be categorized based on length, coarseness, weight, and/or where on the bison it was sheared from. The insulation can be batted, woven, knit, loose, and/or other similar types. The insulation can be used for garments, outdoor equipment, bedding products, and/or other products. The weight of the insulation can be between 40 grams per square meter and 500 grams per square meter. The bison fiber can be blended with recycled polyester, bison fiber, wool, bast fiber, cellulose fiber, and/or synthetic fiber. The adhesives can be low-melt poly, or resin.

### CROSS-REFERENCE TO RELATED APPLICATIONS

This application claims priority to U.S. Provisional Patent Application No. 62/796,210 filed on Jan. 24, 2019, entitled “BISON FIBER BATTING,” which is hereby incorporated by reference in its entirety.

### TECHNICAL FIELD

The disclosed teachings relate to compositions of fibrous insulating material. More specifically, to compositions including bison fibers.

### BACKGROUND

Thermal insulation describes how well a material or substance can reduce heat transfer between objects that are touching or in close proximity. Generally, thermal insulation is based on thermal conductivity, thermal resistance, thermal transmittance, and surface emissivity. Thermal conductivity is a measure of how well a material conducts heat. The lower the thermal conductivity, the greater the material's ability to resist heat transfer (e.g., better insulation). Thermal resistance measures a material's ability to resist heat flow. Thermal transmittance is a measure of the rate of transfer of heat through a matter. Surface emissivity measures the ability of a matter to emit energy as thermal radiation. All these measurements, and more, can be studied to determine the thermal qualities of a material.

In addition to thermal insulation, many other factors must be accounted for when determining which material in best suited for use in extreme weather conditions. For example, manufacturers of insulating battings must take into consideration physical properties such as the water resistivity, thickness, permeability, warm-when-wet capability, and several other factors. Manufacturers must also consider market factors such as the availability of the material, difficulty to manufacturing, costs, etc. Currently, various natural and synthetic materials are known for use in insulting battings in garments, blankets, and the like. Ideally, insulating battings should be, for example, temperature regulating, hypoallergenic, warm-when-wet, have good shape retention qualities, be lightweight, and be flexible. One such material is bison fiber.

Bison are molting animals which shed their coats in the spring of each year. Native Americans have used the fiber for rope, stuffing for insulation, fiber art, and more. This textile fiber can be utilized to add value to animals raised for breeding and for slaughter. Although bison fiber has been used for textile products, its textile properties are beginning to be understood only recently.

### BRIEF SUMMARY

The disclosed embodiments include an insulation that incorporates bison fiber and other materials such as recycle polyester. Bison fibers are a largely underutilized natural fiber that are a byproduct of the bison ranching industry. The properties of bison fibers have started to be studied more thoroughly in recent years. Currently, researchers have studied the fineness of the fibers, the moisture regain of the fibers, the difference in the fibers sheared from different parts of the bison, and the differences between fibers from bison of different sexes and status within the herd.

Raw bison fiber can be collected by picking the excess from fences, brush, tall grass, trees, rubbing posts, or the like when the bison are shedding. During the spring season, which is when bison shed, larger portions of bison wool (“tags”) can be found near bison grazing areas, hanging off bison, or in areas where bison migrate through. Once gathered, the fiber can be used for multiple purposes. Bison wool, generally, has a length of 1-2 inches, does not shrink when washed, and does not contain lanolin. Lanolin is usually found on wool bearing animals and protects the animals from the environment.

The disclosed embodiments also include a method specific to processing raw bison fiber. The method includes shearing the bison fiber from the bison, scouring or cleaning the fiber, blending the fiber, carding the fiber, and finally using manufacturing techniques to shape the fiber for use as insulation in, for example, a garment or blanket. Shearing of the fiber can be done in multiple ways, such as an in an industrial setting, or the fiber can be gathered after it falls off a bison. Scouring removes the dirt and other foreign contaminates, and the dehairing process separates the fiber based on micron range. In the carding process, the fibers are untangled and organized in a manner that allows for further processing.

This Summary is provided to introduce a selection of concepts in a simplified form that is further described below in the Detailed Description. This Summary is not intended to identify key features of the claimed subject matter, nor is it intended to be used to limit the scope of the claimed subject matter. Other aspects of the disclosed embodiments will be apparent from the accompanying Figured and Detailed Description.

### BRIEF DESCRIPTION OF THE DRAWINGS

The techniques introduced herein may be better understood by referring to the following Detailed Description in conjunction with the accompanying drawings, in which like reference numerals indicate identical or functionally similar elements.

FIG. 1 is an illustration that depicts a bison with a coat of fibers.

FIG. 2 is an illustration that depicts a tree with bison wool collected on its branches.

FIG. 3 is a flowchart illustrating a method used to process bison wool in accordance with one embodiment of the present disclosure.

FIG. 4 is an illustration of the relationship between the fiber diameter in microns and coarseness.

FIG. 5 is an illustration of the layers of a garment that can use the insulation made in accordance with one embodiment of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying figures, those skilled in the art will understand the concepts of the disclosure and will recognize applications of these concepts that are not particularly addressed herein. It should be understood that these concepts and applications fall within the scope of the disclosure and the accompanying claims.

The purpose of the terminology used herein is only for describing embodiments and is not intended to limit the scope of the disclosure. Where context permits, words using the singular or plural form may also include the plural or singular form, respectively.

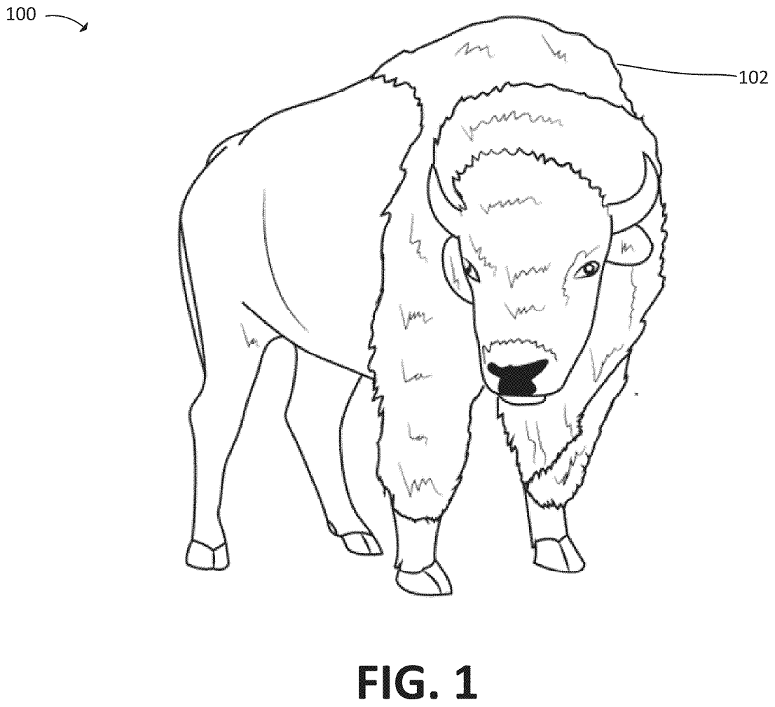

FIG. 1 illustrates a bison with a coat of fibers that can be sheared and used in conjunction with elements of the present disclosure. Bison 100 includes bison fiber 102. Bison 100 can be of any species. There are two surviving species of bison, the American bison and the European bison. The American bison and European bison, although superficially similar, have drastic physical and behavioral differences. For example, the American bison tend to graze more, have lower hanging heads, and are more easily tamed. Importantly, American bison have hairier bodies than their European counterparts. Thus, making them more suitable for extracting bison fibers.

Bison shed their coats (e.g., bison fiber 102) in the spring of each year. Generally, bison fiber 102 is made up of coarse guard hairs and fine downy hairs. The guard hairs are hollow and range from 21 to 110 microns in diameter, with an average of 59 microns. The fine downy hairs are solid and are covered in fine scales. Downy fibers range in diameter from 12 to 29 microns. Bison coats have been used for various purposes for hundreds of years. For example, Native Americans used bison fiber 102 for rope, stuffing for insulation, and fiber art. Since then, bison fiber 102 has been a largely underutilized natural fiber that is a byproduct of the bison ranching industry. However, the functionality, use, and characteristics of bison fiber 102 are still being discovered. Researchers have begun to understand the fineness, the moisture regain capabilities, and other aspects of bison fiber 102.

For example, researchers have studied the differences between bison fiber 102 from two female bison, where one was considered to be dominant and the other a subordinate. The dominant bison had bison fiber 102 that averaged 21.8 microns in diameter and the subordinate bison has bison fiber 102 that averaged 18.8 microns in diameter. These micron ranges are significant when compared to other common fibers or hairs. For example, human hair is approximately 75 microns, merino cashmere is approximately 14 microns, and wool yarns are approximately 10 to 20 microns. Thus, bison fiber 102 can provide a comfortable alternative to current options.

Furthermore, researchers have studied bison fiber 102 for its moisture regaining capabilities. Moisture regain is a measure of the amount of moisture a fiber can hold without feeling wet and is used to understand the comfort level of a fiber. Thus, the more moisture a fiber can hold, the more comfortable it is to wear. Generally, bison fiber 102 had a moisture regain of 13 to 20 percent. In comparison, sheep's wool has a range of 14 to 16 percent.

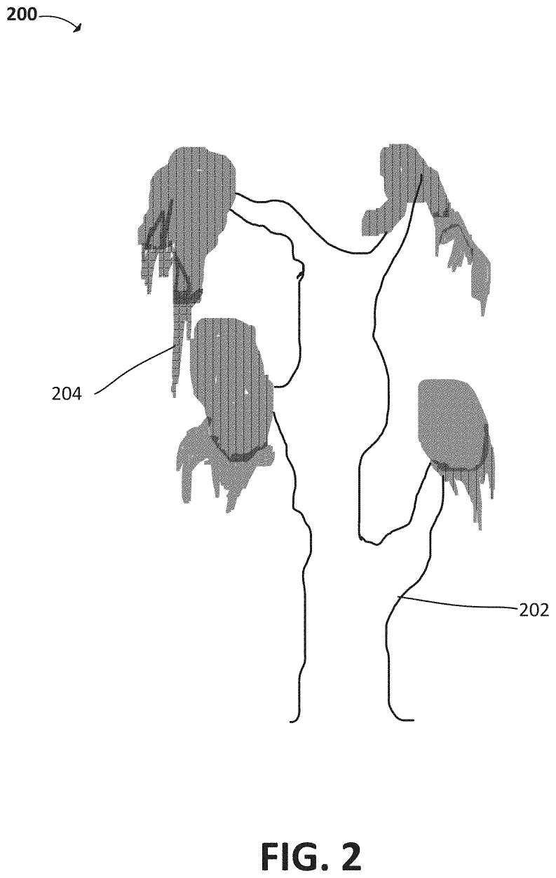

FIG. 2 illustrates a possible location to find and gather bison fibers. Fiber chucks 200 includes tree 202 and raw fiber 204. In some embodiments, tree 202 can alternatively be other objects within a bison's habitat. For example, tree 202 can be fences, brush, tall grass, and/or a rubbing post. Generally, bison have two layers of hair (e.g., wool, fiber, etc.). There is a thin layer of soft fine hair and an outer layer of coarse thick hair. The soft fine hair functions as insulation during the cold seasons. Conversely, the outer layer consists of coarse thick hair, which are shed in large clumps during the spring. The bison then regrow the outer layers during the fall months. Big chucks of fiber that fall off bison are called tags. Tags can be found caught in tall grass or against a tree during bison shedding season. In some cases, a bison farmer may have a rubbing post within the ranch, where bison can rub the excess hair off and thus, hasten the natural shedding process.

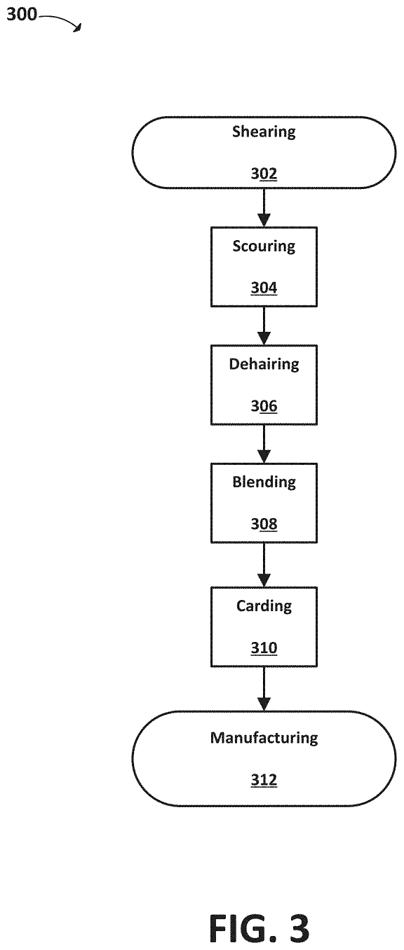

FIG. 3 is a flowchart of an embodiment of the method used to process bison fiber for use as insulation in, for example, garments, blanket, and the like. Method 300 includes shearing 302, scouring 304, blending 308, carding 310, and manufacturing 312. Shearing 302 can be one method of collecting bison hair. Shearing 302 is the process of shaving bison hair. The bison hair can be from various body parts (e.g., torso, head, underbelly, and/or legs). However, traditionally, bison hair is shaved from the torso region. Furthermore, although bison coats are at their fullest and longest during the end of the winter months, thus, it may be optimal to shave the bison during the winter, shearing can be done at any time.

In some embodiments, shearing 302 may not be necessary because the bison naturally shed most of their hair. For example, a herd of bison may be grazing within an enclosed 100-acre ranch. Within the 100 acres, a bison rancher may be able to collect previously shed hair from trees, grass, brush, fences, and/or other areas that the bison graze in. In some embodiments, shearing 302 can be also be done by using a shearing machine such as a sheep shearer.

Additionally, various shearing 302 methods can be used. In some embodiments, a shearer can use The Bowen Technique, the Tally-Hi method, and/or similar methods. For example, a bison can be allowed to graze within an enclosed 100-acre ranch. During the end of the winter months and beginning of the spring months, the bison may be sheared using The Bowen Technique. The Bowen Technique involves used rhythmical sweeps of the shearing tool to minimize the time and effort spent per bison.

During scouring 304, dirt and foreign contaminants are removed from the bison fiber through various methods. In some embodiments, the raw fiber can be passed through tanks filled with water and a cleaning agent (e.g., soap and/or detergent). After which, the fiber can be rinsed and naturally dried prior to further processing. In some embodiments, prior to being immersed in water tanks, the raw fiber can be passed through a fanning process where the large debris is blown away prior to the water tanks. In some embodiments, after being immersed in the water tanks, the scoured fiber can be air dried and/or fanned.

In the dehairing 306 stage, the scoured fiber is separated based on its qualities such as the diameter of each strand. Generally, dehairing 306 removes unwanted hair (e.g., coarse hair), which leaves only the soft fibers. In some embodiments, the soft fibers make up approximately 90% to 95% of the entire cleaned raw fiber. In some embodiments, the cleaned fiber is passed through a Cormatex dehairing machine. The Cormatex machine includes a series of interlocking toothed roller which function to separate the cleaned fiber into strands. In some embodiments, dehairing 306 can be repeated multiple times using a Cormatex machine, and/or a similar machine. For example, a manufacturer of bison fiber insulation may guarantee customer that their insulation only bison fiber strands with a diameter between 15 and 20. Thus, in order to avoid customer complaints, the manufacturer may pass a given bison fiber mass through a Cormatex machine multiple times.

In some embodiments, dehairing 306 can include separating the fiber into various levels of marketable fiber based on the diameter of the strands. Generally, there are four different levels of marketable fiber: prime, drop A, drop B, and drop C. Fibers that are grouped into the prime category are of the highest quality, such as cashmere. Drop A includes the next tier of fibers (e.g., less fine). Drop B includes felt-like quality fiber. Drop C includes fiber than can be used for industrial or agricultural purposes. For example, a Cormatex machine may be fed 30 lbs. of cleaned bison fiber to be dehaired. The batch can include both coarse and fine short haired fibers. The Cormatex can separate the batch, based on the diameter of each strand in the batch, into 10 lbs. of drop A, 10 lbs. in drop B, and 10 lbs. in drop C. In some embodiments, a machine can be preprogrammed to separate a fiber mass based on the diameter. For example, a machine can be programmed to group strands with a diameter between 10 microns and 15 microns into the prime category, strands with a diameter between 16 microns and 20 microns into the drop A category, strands with a diameter between 21 microns and 25 microns into the drop B category, and strands with a diameter between 26 microns and 30 microns into the drop C category.

During blending 308, dehaired bison fiber is combined with fibers from, for example, of different animals, length, thickness, and/or color. Blending 308 can be done to incorporate and distinguish desirable characteristics such as durability, flexibility, strength, costs, color, texture, and/or other relevant characteristics. Thus, for example, during blending 308, bison fibers from the dehairing 306 stage, can be blended with other fibers so that the final product is a better thermal insulator. The other fibers can be, for example, recycled polyester, bison fiber, wool, bast fiber, cellulose fiber, and/or synthetic fiber.

In some embodiments, dehaired fiber is fed into a mixing picker machine. A mixing picker machine mechanically disentangles and opens a fiber mass after scouring and dehairing. The machine functions using a rotating cylinder with long pins that comb through the fiber. This helps remove impurities (e.g., dust, and/or vegetable matter) and makes blending 308 more efficient. In some embodiments, the dehaired fiber can be sprayed with compounds to ease the blending process. For example, dehaired fiber can be sprayed with oil, anti-static compounds, and/or anti-foam compounds.

In some embodiments, blending 308 includes combining various amounts of the same fiber (e.g., bison fiber) taken from different lots or body parts of the bison to achieve a uniform result. Uniformity can be based on color, texture, length, and/or other relevant characteristics. For example, brown bison wool can be blended with white sheep wool. However, to obtain a one to two ratio of white wool to brown wool, more or less of each wool can be added or removed. In another example, bison fiber with diameters of 15 microns and 20 microns can be blended together. However, to achieve a higher comfort level, more fibers with diameters of 15 microns can be added. In some embodiments, binders can used to better bind multiple fibers together. For example, poly (lactic acid) can be used to bind various fibers. In some embodiments, low melt poly and a resin spray (e.g., a water-based poly vinyl acetate) can be used for their binding properties.

In some embodiments, blending 308 may include using bast fibers such as hemp and/or flax, cellulose fibers such as cotton, lycocell, viscose, and/or tencel, keratin fibers such as wool, and/or synthetic fibers such as polyester. In some embodiments, bison fibers can make up between 5% to 100% of the post-blended product. For example, drop B bison fiber can be blended with cotton at a two-part bison fibers to one part cotton ratio to make insulation for jackets.

In some embodiments, blending 308 may result in B100 highloft fill. B100 highloft fill includes bison fiber blended with recycled polyester, and a binding agent to bind the fibers together. Generally, B100 highloft fill includes 190 grams per square meter (“gsm”) batted insulation made up of 50% bison fiber, 25% recycles polyester, 25% low-melt poly, and resin spray adhesive. In some embodiments, blending 308 may result in B100 needle punch fill. B100 needle punch fill includes 90 gsm needle-punched insulation made of 50% bison fiber, 25% recycled polyester, and 25% low-melt poly. Both these fillings can be used as, for example, fill for jackets, vests, comforters, gloves, and/or other products.

During carding 310, the blended fiber passes through a series of rollers with fine pointed wire (e.g., similar to a hair brush or comb) of varying sizes and running at various speeds. As the blended fibers goes through the carding 310 process, the fibers are straightened, and the individual strands are arranged in parallel to each other. In some embodiments, the carded fiber can be sent to a rolling machine that condenses the fibers into a cylindrical form. This added step can make it easier to use the fibers for stitching or other manufacturing processes.

Manufacturing 312 can include various processes such as, for example, spinning and/or twisting. Spinning involves passing carded fiber in between two rollers to reduce the diameter and winding the thinned fiber onto a bobbin. Twisting involves a similar process to spinning, but the fiber is twisted while being spun onto a bobbin. This allows for a softer and bulkier fiber for future use. In some embodiments, manufacturing 312 can includes making insulation for various types such as batted (non-woven), knit, needle punch, woven, loose, and/or other similar types.

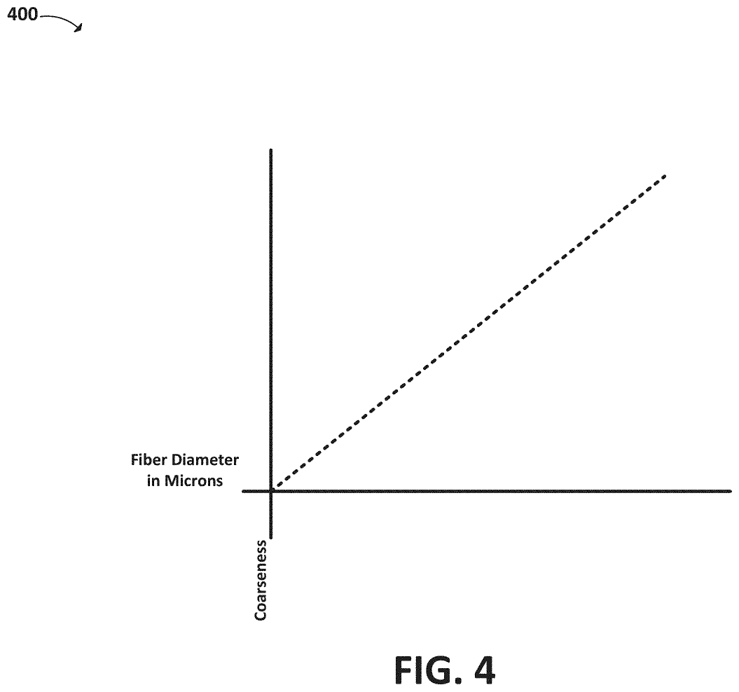

FIG. 4 is graph illustrating the relationship between fiber diameter in microns and coarseness. Generally, the larger the diameter of the fiber, the coarser the fiber will feel to the touch. For example, cotton fluff or “down” ranges between 21 to 24 microns, alpaca fur ranges between 30 to 32 microns, coarse outer bison hair is approximately 55 microns, and bison hair found near a bison's cape and tail is approximately 98 microns. Thus, insulation can include bison fibers of various diameters. In some embodiments, every strand of bison hair in a fiber mass (e.g., a batch) is used in some way. For example, the finer hairs (e.g., prime and/or drop A) can be used for light weight insulation such as in wearable garments (e.g., jackets, best, or gloves). The coarser fibers (e.g., prime b, or prime c) can be for heavier insulation such as, for example, in blankets, sleeping bags, or beds.

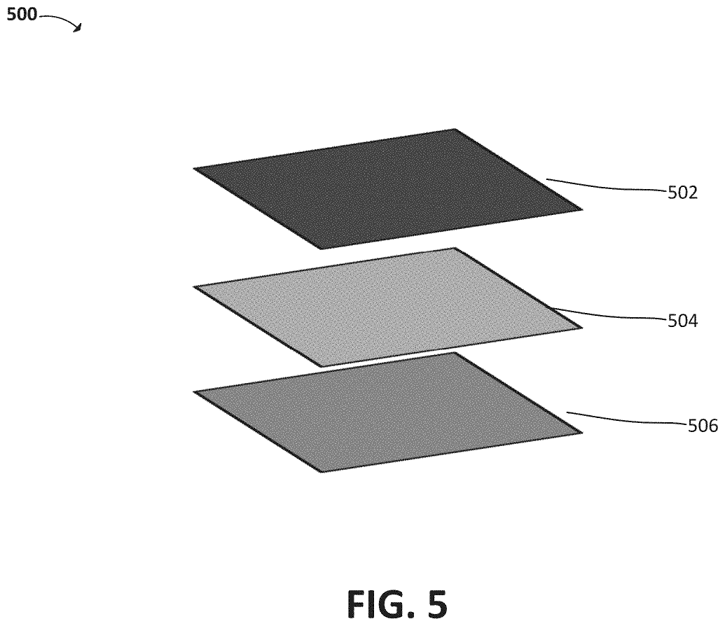

FIG. 5 is an illustration of the layers of a garment using the insulation described herein. Garment layers 500 includes outer layer 502, insulation 504, and lining 506. Outer layer 502 can have qualities such as being water repellent, water proof, wind blocking, wind proof, and/or other applicable qualities. For example, outer layer 502 can be a composition of rubber, polyvinyl chloride, polyurethane, silicone elastomer, fluoropolymers, and/or wax. Insulation 504 can include bison fibers. For example, insulation 504 can be made of B100 highloft batted insulation as described in further detail above. In another example, insulation 504 can be made 100% bison fiber. In yet another example, insulation 504 can include a combination of prime bison fibers and drop C bison fibers. In other words, the composition of insulation 504 can vary based on the need, product, target weather conditions, target comfort level, and/or other relevant characteristics. Lining 506 functions as the interior of a product. It can be made of known in the art materials such as silk, cotton, polyester, and/or other materials.

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

Reference herein to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. It will be appreciated that the same thing can be said in more than one way. One will recognize that “fiber” and “hair” are one form of a “wool” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. An insulation comprising:
a lightweight insulation including:
a first batch of bison fiber, wherein the first batch of bison fiber is categorized as any of prime, or drop A;
a first fiber blended with the first batch of bison fiber; and
a first binding agent operable to bind the first batch of bison fiber and the first fiber; and
a heavy weight insulation including:
a second batch of bison fiber, wherein the second batch of bison fiber is categorized as any of drop B, or drop C;
a second fiber blended with the second batch of bison fiber; and
a second binding agent operable to bind the second batch of bison fiber and the second fiber.

2. The method of claim 1, wherein the first fiber and second fiber is any of recycled polyester, bison fiber, wool, bast fiber, cellulose fibers or synthetic fiber.

3. The method of claim 1, wherein the insulation has a weight between 40 grams per square meter and 500 grams per square meter.

4. The method of claim 1, wherein the insulation is any of a batted, knit, needle punch, woven, loose, or blown-in insulation.

5. The method of claim 1, wherein the bison fiber exhibits a diameter of 14 microns to 30 microns.

6. The method of claim 1, wherein the first binding agent and second binding agent is any of a low-melt poly, or resin.

7. The method of claim 1, wherein the insulation comprises between 5% to 100% bison fiber.

8. The method of claim 1, wherein the insulation includes 50% bison fiber, 25% recycled polyester, and 25% low-melt poly.

9. A method for producing insulation from bison hair, the method comprising:
shearing a batch of bison hair;
scouring the batch of bison hair;
dehairing the batch of bison hair, wherein dehairing further includes:
separating the batch of bison hair into one of a prime category, a drop A category, a drop B category, or a drop C category;
blending the batch of bison hair with a fiber and a binding agent to produce a blended fiber; and
carding the blended fiber to produce insulation.

10. The method of claim 9, wherein shearing comprises any of the Tally-Hi method, or the Bowen Technique.

11. The method of claim 9, wherein scouring further includes:
immersing the batch of bison hair into water tanks, wherein the water tanks include water and a cleaning agent.

12. The method of claim 9, wherein scouring further includes:
air-drying the batch of bison hair.

13. The method of claim 9, wherein separating the batch of bison hair further includes:
separating the batch of bison hair based on the diameter of each strand measured in microns.

14. The method of claim 9, wherein the fiber can be any of recycled polyester, bison fiber, wool, bast fiber, cellulose fiber, or synthetic fiber.

15. The method of claim 9, wherein the binding agent can be any of low-melt poly, or resin.

16. The method of claim 9, wherein blending further includes:
spraying the batch of bison hair with any of an oil, anti-static compound, or anti-foam compound.

17. The method of claim 9, wherein the blended fiber includes 50% bison fiber, 25% recycled polyester, and 25% low-melt poly.

18. The method of claim 9, wherein carding further includes:
organizing the blended fiber such that the individual strands of the fiber are parallel to each other.

19. An insulation comprising:
a batch of bison fiber, wherein each strand of fiber within the batch of bison fiber is categorized as any of prime, drop A, drop B, or drop C;
recycled polyester blended with the batch of bison fiber; and
a binding agent operable to bind the batch of batch of bison fiber and the recycled polyester.

20. The insulation of claim 19, wherein the insulation includes 50% bison fiber, 25% recycled polyester, and 25% binding agent.

21. The insulation of claim 20, wherein the binding agent can be any of low-melt poly, or resin.

22. The insulation of claim 19, wherein the insulation is any of a batted, knit, needle punch, woven, loose, or blown-in insulation.
